(19) United States
(12) Patent Application Publication
(10) Pub. No.: US 2017/0310791 A1
(43) Pub. Date: Oct. 26, 2017

(54) PERFORMANCE-BASED GENERATION OF CONTENT

(71) Applicant: ServiceNow, Inc., Santa Clara, CA (US)

(72) Inventors: Paul Palse, Amsterdam (NL); Stefaan Vandenbussche, Amsterdam (NL); Elliot Monifi, Amsterdam (NL); Oriol Arbones, Amsterdam (NL)

(21) Appl. No.: 15/484,945

(22) Filed: Apr. 11, 2017

Related U.S. Application Data
(60) Provisional application No. 62/325,227, filed on Apr. 20, 2016.

(51) Int. Cl. H04L 29/06; H04L 12/26; H04L 29/08

(52) U.S. Cl. CPC H04L 67/42; H04L 67/1002; H04L 43/16; H04L 67/02

(57) ABSTRACT

A system and method for performance-based generation of content for a component referenced for display within a webpage have been provided. The system includes a server having a processor and a memory that includes instructions executable by the processor to receive a request from a client application executing on a client device for content for the component and to transmit a response to the client device. The response is based on performance measurements of prior requests for the content and is used by the client application to render the component on a display connected to the client device.

### CROSS-REFERENCE TO RELATED APPLICATION(S)

This application claims the benefit of U.S. Provisional Application No. 62/325,227, filed Apr. 20, 2016, the entire contents of which are hereby incorporated by reference in its entirety.

### BACKGROUND

An application software can allow users to configure home or dashboard webpages to include multiple components, which can also be referred to as widgets. For example, an application can be provided to permit the configuration of components on a webpage, such as to add, remove, or locate components to, from, or on the webpage. When the webpage is accessed, each component or widget renders its associated content.

### SUMMARY

Disclosed herein are implementations of performance-based generation and display of content in a webpage.

In an implementation, a system for performance-based generation of content for a component referenced for display within a webpage is provided including a server having a processor and a memory that includes instructions executable by the processor to receive a request from a client application executing on a client device for content for the component and to transmit a response to the client device. The response is based on performance measurements of prior requests for the content and is used by the client application to render the component on a display connected to the client device.

In an implementation, a method for performance-based generation of content for a component referenced for display within a webpage is provided. The method includes receiving a request from a client application executing on a client device for content for the component and transmitting a response to the client device. The response is based on performance measurements of prior requests for the content and is used by the client application to render the component on a display connected to the client device.

In an implementation, a non-transitory computer-readable storage medium for performance-based generation of content for a component referenced for display within a webpage is provided. The non-transitory computer-readable storage medium includes program instructions executable by one or more processors that, when executed, cause the one or more processors to perform operations, the operations comprising receiving a request from a client device to display the webpage on the client device, determining whether to generate the content for the component based on performance measurements associated with the component, generating the content for the component responsive to a determination that the performance measurements satisfy a performance threshold, and sending a response to the client device including the generated content.

These and other aspects of this disclosure are disclosed in the following detailed description, the appended claims, and the accompanying figures.

### BRIEF DESCRIPTION OF THE DRAWINGS

The description herein makes reference to the accompanying drawings wherein like reference numerals refer to like parts throughout the several views.

FIG. 1 is a block diagram of an example of an electronic computing and communications system in accordance with the present disclosure.

FIG. 2 is a block diagram of an example internal configuration of a computing device of an electronic computing and communications system in accordance with the present disclosure.

FIG. 3 is an example of a user page that illustrates performance-based selective generation of content in accordance with the present disclosure.

FIG. 4 is a block diagram of an example of a system for performance-based generation of content in accordance with the present disclosure.

FIG. 5 is an example of a data structure used with a performance-based content generation system in accordance with the present disclosure.

FIG. 6 is a flow diagram of an example for performance-based content generation in accordance with the present disclosure.

FIG. 7 is a flow diagram of an example of steps for generating component content of a performance-based content generation system in accordance with the present disclosure.

FIG. 8 is an example of a technique for performance-based generation of content for a component in accordance with the present disclosure.

### DETAILED DESCRIPTION

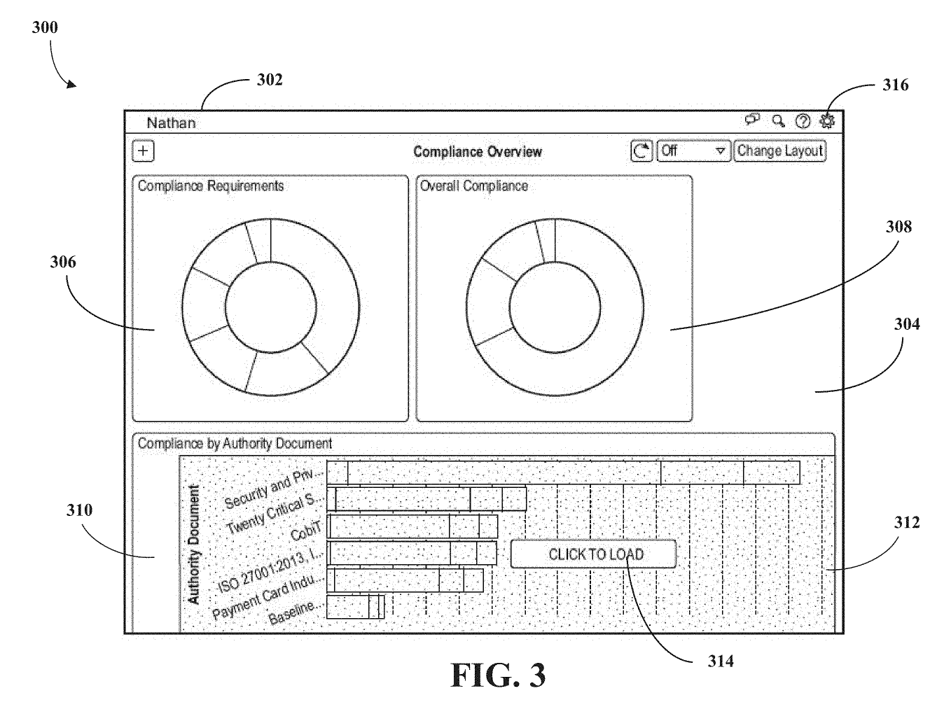

A user can configure an application webpage, such as a home page or dashboard, to render widgets or components that can, for example, contain data of different types and/or data from different sources. For example, such as further described and illustrated with respect to FIG. 3, a component or widget can provide content that is rendered within a sub-area of a graphical user interface of a webpage. In some implementations, a component or widget can be implemented separately from the application webpage in which it is later incorporated. The terms widget and component are used interchangeably herein.

A component can include but is not limited to key performance indicators, information relevant to the user's role, a feed the user has subscribed to, upcoming deadlines for the user, reports, results of queries, graphical displays of results of queries, a project timeline, and any combination thereof. Content for components can be generated from application-provided or user-created queries, reports, scripts, and the like (collectively referred to as reports). When a user visits a configured webpage or dashboard, each of the components on the page will display the content it is configured or referenced to display. Users generally expect webpages to be displayed quickly after a request for the webpages so the loading time of a webpage and its constituent components or widgets is an important performance metric.

Several factors can impact the time needed to load or generate content (i.e., generation time) for a component. The generation time can, for example, depend on the input value to the reports. The generation time can also be impacted by other factors such heavy application use, data growth, database configuration or tuning, database query structure, sub-optimal application logic, and the like. The time to load a webpage can be correlated to the time required to load or generate content of the individual components of the webpage. A webpage that takes a long time to display can lead to user frustration and lower user productivity. In some situations, generating the content of a component may be unnecessary, such as if the component is not pertinent to the user's current task.

To address such problems, it is desirable to determine whether a particular component should be generated based on various performance metrics and a plurality of information/data in order to reduce the loading time of a webpage. Whether to generate and display content of a particular component can be based on historical performance data regarding generating the content of the component. In addition, the decision to generate the content or not can be based on data analysis of other similar contexts based on the user profiles, computing devices utilized by the users, and the webpages being loaded. The type, category, or identity of a component may also be taken into account. For example, a component may be more or less important or relevant to a user (based on information including but not limited to what is known about the user or previous browsing histories), thereby affecting the determination. The components can also garner ratings based upon feedback from the user after the content of the components have been displayed and these ratings can also be utilized to make determinations on whether to generate and display content of a particular component.

Scripts that generate content of components can be used by more than one user or in different contexts (for example, in different webpages). The time required by the application to generate the content can differ, such as by user, by how the content is used, when the content is generated, or combinations thereof. For example, one user may specify different query parameters than another user thereby impacting the query performance. As an illustration, a first user who provides query criterion such as “where name like % jones %” can experience markedly different results than a second user who provides query criterion “where name like jones %” to the same query. For example, the first user's query can cause a full table scan while the second query causes a database to use a table index. Historical performance measurements can be collected in more than one context.

When an application processes a report (used to generate content of the component of a webpage) in response to receiving a request from a user for the report, it can record the time it required to generate the report. The recorded time can be aggregated with other generation times of the report. The application can record generation times for a user individually and/or for all users collectively. It can also determine aggregate statistics including but not limited to the count, average, running average, or weighted average of the measured performance.

When the application receives a request for a page that contains at least one component, a report processor can determine whether to generate the content of the at least one component based on any of the historical generation times of the content, a predetermined threshold capping the generation time, and a plurality of other performance measurements and system/user preferences. The determination to generate content can be made regarding any of a plurality of components. For example, if a webpage has three components, the processor can determine that generating content of all three components will meet performance requirements or it can determine that the generation of content for one of the three components would take too long and so should not occur.

For example, if the report processor determines that the content is taking or would take too long to generate, placeholder content can instead be generated and utilized as a substitution for the content of the component. In an implementation, the placeholder content resembles the content of the component (e.g., is a simplified rendering including but not limited to a black/white version). In another implementation, the placeholder content is an indication that indicates that the requested content will not or should not be generated.

Depending on the implementation, whether content is to be generated can be determined by a client (i.e., the requester of the webpage) or by the server (i.e., the receiver of the request). If the determination is made client side, the client can, for example, not make a request for component content and can instead display placeholder content already available to the client or available based on previous viewing histories. Or, the client can override or reject an indication or response from the server that states that the content of the component should not be generated. In another implementation, if the determination is made server side, the server can, for example, determine not to generate the content of the component based on historical data, known user preferences, or learned user preferences even if the content of the component does not cause performance issues.

Implementations described herein may be configured such that the generation of content of the components is based on an analysis by both the client and the server. For example, the client may request that content related to a certain component be generated regardless of performance conditions being determined to be less than optimal (including but not limited to the performance measurements exceeding a predetermined threshold that indicates the generation of the content would require too much processing power or loading time) by the server. In another example, the server may determine not to generate content associated with a certain component even if the performance conditions are adequate or optimal based on historical data and/or preferences of the client (e.g., the user never clicks on the content of a certain component and so the server decides to not generate that content even though generation wouldn't result in significantly longer loading times).

Collection and aggregation of historical performance information can be performed asynchronously. For example, a thread or an event processor that executes independently of the process or thread responding to a user request can be utilized to process the historical performance information. When the report processor completes the execution of a report, it issues a request to the event processor to update the performance information based on the generated report. The request to the event processor can be an asynchronous event. Asynchronous processing of performance information can reduce the impact that performance measurement might have on the time needed to generate the report/content.

Implementations of this disclosure provide technological improvements that are particular to computer networks, for example, those concerning generating webpages configured with multiple components. Computer network-specific technological problems, such as reducing the response time of webpage generation and associated component content, can be wholly or partially solved by implementations of this disclosure. For example, implementation of this disclosure reduces the response time of webpage generation by determining whether to generate the content of at least one of a plurality of components based on any of user preferences, historical performance metrics/measurements, other information, and any combination thereof. Implementations of this disclosure can thus introduce new and efficient improvements in the ways in which webpages are generated by selectively generating content of components on a webpage.

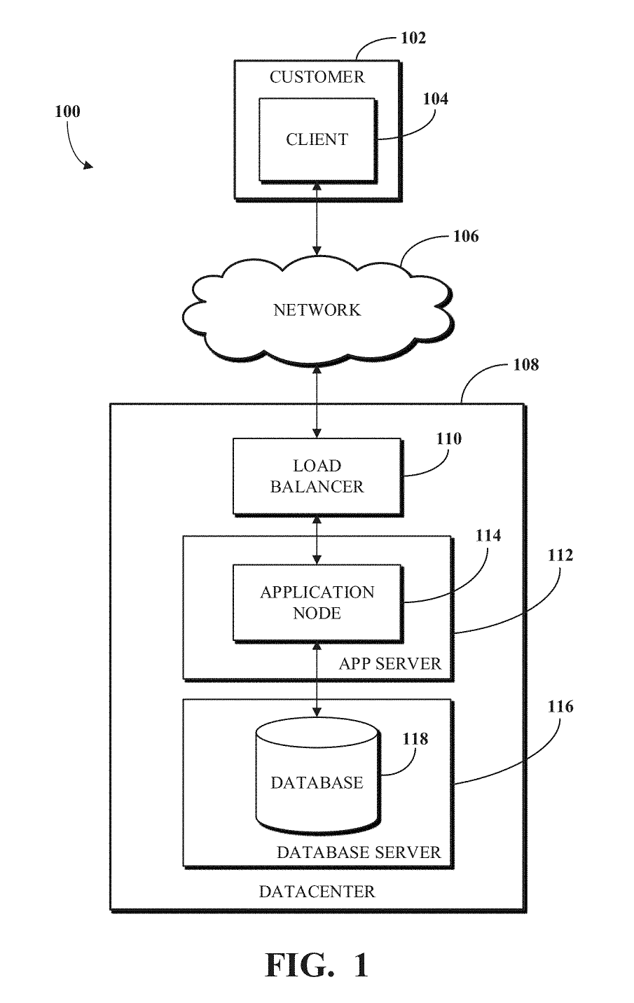

To describe some implementations in greater detail, reference is first made to examples of hardware structures. FIG. 1 is a block diagram of an example of an electronic computing and communications system 100 in accordance with the present disclosure. As used herein, the term “electronic computing and communications system,” or variations thereof, can be, or include, a distributed computing system (e.g., a client-server computing system), a cloud computing system, a clustered computing system, or the like.

The system 100 can include one or more customers 102, which may be a public entity, private entity, or other corporate entity or individual that purchases or otherwise uses services of a software provider, such as a PaaS service provider. The customer 102 can include one or more clients. For example, and without limitation, the customer 102 can include a client 104. The client 104 can comprise a computing system, which can include one or more computing devices, such as a mobile phone, a tablet computer, a laptop computer, a notebook computer, a desktop computer, or any other suitable computing device or combination of computing devices. In some implementations, the client 104 can be implemented as a single physical unit or as a combination of physical units. In some implementations, a single physical unit can include multiple clients.

The client 104 can be an instance of software running on a customer device associated with the customer 102. As used herein, the term “software” can include, but is not limited to, applications, programs, instances, processes, threads, services, plugins, patches, application version upgrades, or any other identifiable computing aspect capable of accessing or interacting with, directly or indirectly, a database. The system 100 can include any number of customers or clients or can have a configuration of customers or clients different from that generally illustrated in FIG. 1. For example, and without limitation, the system 100 can include hundreds or thousands of customers, and at least some of the customers can include or be associated with any number of clients. A customer can include a customer network or domain. For example, and without limitation, the client 104 can be associated or communicate with a customer network or domain.

The system 100 can include a datacenter 108. The datacenter 108 can include one or more servers. For example, and without limitation, the datacenter 108, as generally illustrated, includes an application server 112 and a database server 116. A datacenter, such as the datacenter 108, can represent a geographic location, which can include a facility, where the one or more servers are located. The system 100 can include any number of datacenters and servers or can include a configuration of datacenters and servers different from that generally illustrated in FIG. 1. For example, and without limitation, the system 100 can include tens of datacenters, and at least some of the datacenters can include hundreds or any suitable number of servers. In some implementations, the datacenter 108 can be associated or communicate with one or more datacenter networks or domains, which can include domains other than the client domain.

The client 104 and the servers associated with the datacenter 108 may be configured to connect to, or communicate via, a network 106. Furthermore, a client 104 associated with the customer 102 can connect to the network 106 via a communal connection point, link, or path, or using a distinct connection point, link, or path. A connection point, link, or path can be wired, wireless, use other communications technologies, or a combination thereof.

The network 106 can include, for example, the Internet and/or the network 106 can be, or include, a local area network (LAN), a wide area network (WAN), a virtual private network (VPN), or any other public or private means of electronic computer communication capable of transferring data between a client, such as the client 104, and one or more servers associated with the datacenter 108, or a combination thereof. The network 106, the datacenter 108, or any other element, or combination of elements, of the system 100 can include network hardware such as routers, switches, load balancers, other network devices, or combinations thereof. For example, the datacenter 108 can include a load balancer 110 for routing traffic from the network 106 to various servers associated with the datacenter 108.

The load balancer 110 can route, or direct, computing communications traffic, such as signals or messages, to respective elements of the datacenter 108. For example, the load balancer 110 can operate as a proxy, or reverse proxy, for a service, such as an Internet-delivered service, provided by the datacenter 108 to one or more remote clients, such as the client 104, via the network 106. Routing functions of the load balancer 110 can be configured directly or via a Domain Name System (DNS). The load balancer 110 can coordinate requests from remote clients, such as the client 104, and can simplify client access by masking the internal configuration of the datacenter 108 from the remote clients. Request coordination can include maintaining information for sessions, such as sticky sessions, between a client and a service or software provided by the datacenter 108.

Maintaining information for a sticky session can include maintaining information to forward requests associated with a session from a client to an identified element of the datacenter 108 for the session. A load balancer 110 can operate as a firewall, allowing or preventing communications based on configuration settings. Although the load balancer 110 is depicted in FIG. 1 as being within the datacenter 108, in some implementations, the load balancer 110 can instead be located outside of the datacenter 108, for example, when providing global routing for multiple datacenters. In some implementations, load balancers can be included both within and outside of the datacenter 108.

The datacenter 108 may include an application server 112 and a database server 116. The application server 112 or the database server 116 can be a computing system, which can include one or more computing devices, such as a desktop computer, a server computer, or any other computer capable of operating as a server. In some implementations, the application server 112 or the database server 116 can be non-hardware servers implemented on a physical device, such as a hardware server. In some implementations, the application server 112 and the database server 116 can be implemented as a single hardware server or as a single non-hardware server implemented on a single hardware server. Of course, any number of application servers or database servers can be implemented at the datacenter 108, and the datacenter 108 can include servers other than or in addition to the application server 112 or the database server 116, for example, a web server.

In some implementations, the application server 112 includes an application node 114, which can be a process executed on the application server 112. For example, and without limitation, the application node 114 can be executed in order to deliver services to a client, such as the client 104, as part of web application software. The application node 114 can be implemented using processing threads, virtual machine instantiations, or other computing features of the application server 112. In some implementations, the application node 114 can store, evaluate, or retrieve data from a database, such as the database 118 of the database server 116.

The application server 112 can include any suitable number of application nodes, depending upon a system load or other characteristics associated with the application server 112. For example, and without limitation, the application server 112 can include two or more nodes forming a node cluster. In some implementations, the application nodes implemented on a single application server 112 can run on different hardware servers.

The database server 116 can be configured to store, manage, or otherwise provide data for delivering services to the client 104 over a network. The database server 116 may include a data storage unit, such as a database 118, which can be accessible by software executed on the application node 114. The database 118 may be implemented as a relational database management system (RDBMS), an object database, an XML database, a configuration management database (CMDB), a management information base (MIB), one or more flat files, other suitable non-transient storage mechanisms, or a combination thereof. By way of non-limiting example, the system 100, in some implementations, can include an XML database and a CMDB. While limited examples are described, the database 118 can be configured as or comprise any suitable database type. Further, the system 100 can include one, two, three, or any suitable number of databases configured as or comprising any suitable database type or combination thereof.

In some implementations, the database 118 can be configured as or comprise a CMDB. A CMDB can comprise a plurality of configuration items (CIs), attributes associated with the CIs, or relationships between the CIs. A CI can be a CMDB record that represents an infrastructure entity, device, or units of the system 100. For example, the customer 102, the client 104, the network 106, the datacenter 108, the load balancer 110, the application server 112, the application node 114, the database server 116, the database 118, or any other element, portion of an element, or combination of elements of the electronic computing and communications system 100 can be represented in the CMDB by a CI.

The CMDB can include information describing the configuration, the role, or both the configuration and the role, of an element of the system 100. In some implementations, an MIB can include one or more databases listing characteristics of the elements of the system 100. In some implementations, an object identifier (OID) can represent object identifiers of objects or elements in the MIB.

One or more databases (e.g., the database 118), tables, other suitable information sources, or portions or combinations thereof may be stored, managed, or otherwise provided by one or more of the elements of the system 100 other than the database server 116, such as the client 104 or the application server 112.

Some or all of the systems and techniques described herein can operate or be executed on or by the servers associated with the system 100. For example, performance-based generation of content of a component referenced for display within a webpage can be carried out by the application node 114. In some implementations, the systems and techniques described herein, portions thereof, or combinations thereof can be implemented on a single device, such as a single server, or a combination of devices, for example, a combination of the client 104, the application server 112, and the database server 116.

In some implementations, the system 100 can include devices other than the client 104, the load balancer 110, the application server 112, and the database server 116 as generally illustrated in FIG. 1. In some implementations, one or more additional servers can operate as an electronic computing and communications system infrastructure control, from which servers, clients, or both servers and clients, can be monitored, controlled, configured, or a combination thereof.

The network 106, one or more datacenters, such as the datacenter 108, and one or more load balancers, such as the load balancer 110, may be implemented within a distributed computing system. A load balancer associated with a distributed computing system (e.g., the load balancer 110) can communicate with the network 106, one or more datacenters (e.g., the datacenter 108), other load balancers, or a combination thereof. The load balancer 110 can be configured to route communications to a primary datacenter, identify a failover condition (e.g., an enumerated failover condition) at the primary datacenter, and redirect communications to a secondary datacenter until the failover condition is resolved. Although illustrated as a single unit in FIG. 1, a load balancer 110 can be implemented as multiple physical or logical units. For example, a distributed computing system can include distinct routing units, load balancing units, firewall units, or the like.

The primary datacenter can include a primary database, such as the database 118, and the secondary datacenter can include a secondary database. The secondary database can include an exact or substantially exact mirror, copy, or replication of the primary database. The primary database or the secondary database can be implemented as an RDBMS, an object database, an XML database, one or more flat files, or the like.

An application node implemented within a distributed computing environment can connect to or communicate with the primary database, which can be associated with the datacenter with which the application node is associated, or associated with another datacenter. For example, a primary datacenter can include a primary database and a first set of application nodes. A secondary datacenter can include a secondary database and a second set of application nodes. The application nodes of the first and second sets can provide a software service to remote clients, and can read or write data in the primary database. The secondary database can mirror changes made to the primary database and prevent write operations from being performed directly on the secondary database. In the event that a failover condition associated with the primary database is identified, the secondary database can operate as the primary database and can allow read or write access to data. The primary database can then operate as the secondary database, mirror the new primary database, and prevent direct write access to the new secondary database.

A distributed computing system can allocate resources of a computer network using a multi-tenant or single-tenant architecture, for example. Allocating resources in a multi-tenant architecture can include installations or instantiations of one or more servers, such as application servers, database servers, or any other server, or combination of servers, that can be shared amongst multiple customers. For example, a web server, such as a unitary Apache installation; an application server, such as a unitary Java Virtual Machine; or a single database server catalog, such as a unitary MySQL catalog, can handle requests from multiple customers. In some implementations of a multi-tenant architecture, the application server, the database server, or both can distinguish between and segregate data or other information of the various customers using the system.

In a single-tenant infrastructure (which can also be referred to as a multi-instance architecture), separate web servers, application servers, database servers, or combinations thereof can be provisioned for at least some customers or customer sub-units. Customers or customer sub-units can access one or more dedicated web servers, have transactions processed using one or more dedicated application servers, or have data stored in one or more dedicated database servers, catalogs, or both. Physical hardware servers can be shared such that multiple installations or instantiations of web servers, application servers, database servers, or combinations thereof can be installed on the same physical server. An installation can be allocated a portion of the physical server resources, such as RAM, storage, communications bandwidth, or processor cycles.

A customer instance can include multiple web server instances, multiple application server instances, multiple database server instances, or a combination thereof. The server instances can be physically located on different physical servers and can share resources of the different physical servers with other server instances associated with other customer instances. In a distributed computing system, multiple customer instances can be used concurrently. Other configurations or implementations of customer instances can also be used. The use of customer instances in a single-tenant architecture can provide, for example, true data isolation from other customer instances, advanced high availability to permit continued access to customer instances in the event of a failure, flexible upgrade schedules, an increased ability to customize the customer instance, or a combination thereof.

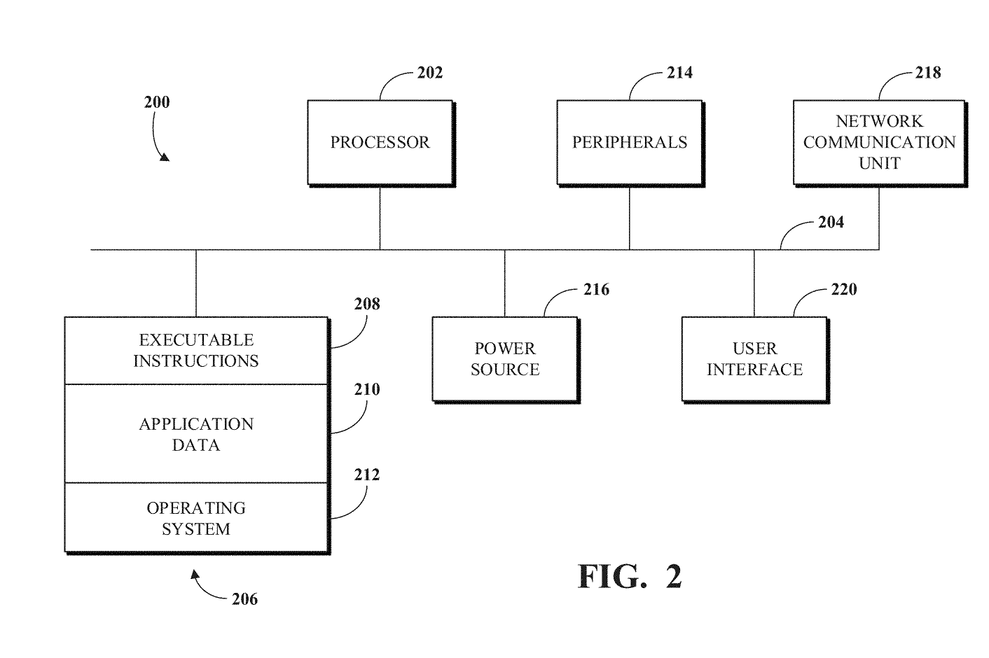

FIG. 2 is a block diagram of an example of an internal configuration of a computing device 200 of an electronic computing and communications system in accordance with the present disclosure, such as a client 104 or a server, such as an application server 112 or a database server 116, of the system 100 shown in FIG. 1. As previously described, a client or server can be a computing system including multiple computing devices or a single computing device, such as a mobile phone, a tablet computer, a laptop computer, a notebook computer, a desktop computer, a server computer, or other suitable computing devices.

A computing device 200 can include components or units, such as a processor 202, a bus 204, a memory 206, peripherals 214, a power source 216, a network communication unit 218, a user interface 220, other suitable components, or a combination thereof.

The processor 202 can be a central processing unit (CPU), such as a microprocessor, and can include single or multiple processors having single or multiple processing cores. Alternatively, the processor 202 can include another type of device, or multiple devices, now existing or hereafter developed, capable of manipulating or processing information. For example, the processor 202 can include multiple processors interconnected in any manner, including hardwired or networked, including wirelessly networked. In some implementations, the operations of the processor 202 can be distributed across multiple physical devices or units that can be coupled directly or across a local area or other suitable type of network. In some implementations, the processor 202 can include a cache, or cache memory, for local storage of operating data or instructions.

The memory 206 can include volatile memory, non-volatile memory, or a combination thereof. For example, the memory 206 can include volatile memory, such as one or more DRAM modules such as DDR SDRAM, and non-volatile memory, such as a disk drive, a solid state drive, flash memory, Phase-Change Memory (PCM), or any form of non-volatile memory capable of persistent electronic information storage, such as in the absence of an active power supply. The memory 206 can include another type of device, or multiple devices, now existing or hereafter developed, capable of storing data or instructions for processing by the processor 202. The processor 202 can access or manipulate data in the memory 206 via the bus 204.

Although shown as a single block in FIG. 2, the memory 206 can be implemented as multiple units. For example, a computing device 200 can include volatile memory, such as RAM, and persistent memory, such as a hard drive or other storage. The memory 206 can be distributed across multiple clients or servers, such as network-based memory or memory in multiple clients or servers performing the operations of clients or servers.

The memory 206 can include executable instructions 208, data, such as application data 210, an operating system 212, or a combination thereof, for immediate access by the processor 202. The executable instructions 208 can include, for example, one or more application programs, which can be loaded or copied, in whole or in part, from non-volatile memory to volatile memory to be executed by the processor 202. The executable instructions 208 can be organized into programmable modules or algorithms, functional programs, codes, code segments, or combinations thereof to perform various functions described herein. For example, the executable instructions 208 can include instructions to selectively generate the content associated with various components of a webpage based on performance metrics and/or user or system preferences.

The application data 210 can include, for example, user files, database catalogs or dictionaries, configuration information or functional programs, such as a web browser, a web server, a database server, or a combination thereof. The operating system 212 can be, for example, Microsoft Windows®, Mac OS X®, or Linux®, an operating system for a small device, such as a smartphone or tablet device; or an operating system for a large device, such as a mainframe computer. The memory 206 can comprise one or more devices and can utilize one or more types of storage, such as solid state or magnetic storage.

The peripherals 214 can be coupled to the processor 202 via the bus 204. The peripherals can be sensors or detectors, or devices containing any number of sensors or detectors, which can monitor the computing device 200 itself or the environment around the computing device 200. For example, a computing device 200 can contain a geospatial location identification unit, such as a global positioning system (GPS) location unit. As another example, a computing device 200 can contain a temperature sensor for measuring temperatures of components of the computing device 200, such as the processor 202. Other sensors or detectors can be used with the computing device 200, as can be contemplated. In some implementations, the power source 216 can be a battery, and the computing device 200 can operate independently of an external power distribution system. Any of the components of the computing device 200, such as the peripherals 214 or the power source 216, can communicate with the processor 202 via the bus 204. In some implementations, a client or server can omit the peripherals 214.

The network communication unit 218 can also be coupled to the processor 202 via the bus 204. In some implementations, the network communication unit 218 can comprise one or more transceivers. The network communication unit 218 can, for example, provide a connection or link to a network, such as the network 106, via a network interface, which can be a wired network interface, such as Ethernet, or a wireless network interface. For example, the computing device 200 can communicate with other devices via the network communication unit 218 and the network interface using one or more network protocols, such as Ethernet, TCP, IP, power line communication (PLC), WiFi, infrared, GPRS, GSM, CDMA, or other suitable protocols.

A user interface 220 can include a display; a positional input device, such as a mouse, touchpad, touchscreen, or the like; a keyboard; or other suitable human or machine interface devices. The user interface 220 can be coupled to the processor 202 via the bus 204. Other interface devices that permit a user to program or otherwise use the computing device 200 can be provided in addition to or as an alternative to a display. In some implementations, the user interface 220 can include a display, which can be a liquid crystal display (LCD), a cathode-ray tube (CRT), a light emitting diode (LED) display (e.g., an OLED display), or other suitable display.

FIG. 3 is an example of a user page 300 that illustrates performance-based selective generation of content in accordance with the present disclosure. The content is of at least one component referenced for display within the user page 300 (i.e., a webpage). The user page 300 can be displayed on a client, such as the client 104 of FIG. 1 or the user interface 220 or the computing device 200 of FIG. 2. The user page 300 can be generated by an application node, such as the application node 114 of FIG. 1. The client 104 can use a web browser application to request and render the user page 300. The user page 300 can contain a page header 302 and a content area 304. The page header 302 contains the name of the user (i.e., “Nathan”) of the user page 300. The page header 302 also contains a plurality of other buttons that are associated with the application associated with user page 300. The content area 304 can be configured to display components. A component can display content generated by a report. In the user page 300, the content area 304 is configured to display three components which are a “compliance requirements” component 306, “overall compliance” component 308, and “compliance by authority document” component 310. Each of the components 306-310 can be configured, for example, to have a respective query run by the application node and display the results graphically. The user page 300 can be configured to display a subset of the components 306-310 or a plurality of other types of components.

In another example, content of a component can be generated by an external source other than the application node. A component can be configured to display its content as a tabular list, graph, chart, any other format, or a combination thereof. However, other techniques can also be used by the components to display data. For example, a component may display no more than a few words or a single a traffic light; however, generating such a simple display may still require a long-running and complex report. The component 306 and the component 308 display their contents, generated as results of performing the respective queries of the components, as doughnut charts. The component 310, on the other hand, displays a placeholder 312.

The placeholder 312 is a greyed out area that overlays the component 310 and indicates that the content of the component 310 is not active content (i.e., the content did not result from the execution of a report). Therefore, the placeholder 312 is used in substitution of the content that results from the execution of the report and is utilized, for example, to improve the loading performance of the user page 300. In another embodiment, the placeholder 312 is not greyed out and is a simple white box or any other simplistic rendering that can be loaded in less time than the content that results from the execution of the report related to the component 310. The placeholder 312 includes an interface element 314 labelled “CLICK TO LOAD.” The interface element 314 can be an action button or another type of button with a plurality of labels. When a user interacts with or activates the interface element 314 (e.g., by using a pointer device to press the button via the web browser application), the content of the component is generated. The placeholder 312 can then be replaced with the generated content of the component 310.

The component 310 can be configured to display a generic placeholder or a representative placeholder for the placeholder 312. A representative placeholder can indicate how content of the component would be displayed. For example, the placeholder 312 is a stacked bar which indicates to the user that the generated content of the component 310 displays as a stacked bar. On the other hand, a generic placeholder may not have any relation to the display of the generated content of a component. The user page 300 also includes a change layout button 316 that can be selected to change the orientation of the components on the user page 300 or select different components to be displayed.

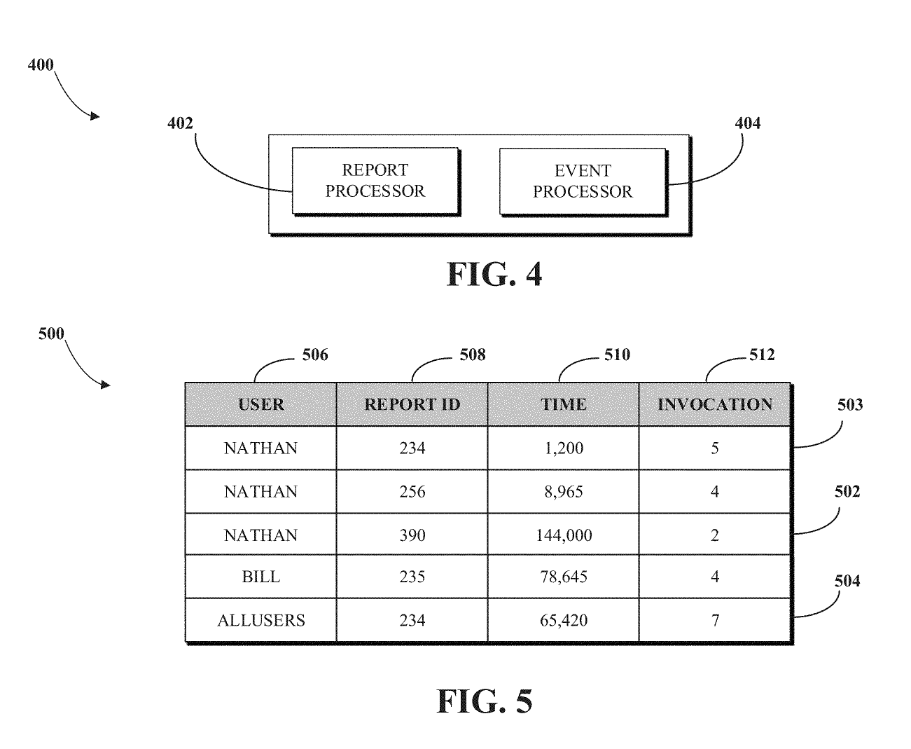

FIG. 4 is a block diagram of an example of a system 400 for performance-based generation of content in accordance with the present disclosure. The system 400 generates content for display on a user page/webpage, such as the user page 300 of FIG. 3. The system 400 can be executed on an application server, such as the application server 112 of FIG. 1 or on an application node, such as the application node 114 of FIG. 1. The content generated by the system 400 can be HTML, XML, JSON, a platform-specific control, structured data, a stream of data, and the like. The system 400 can be a web service application that responds to requests formatted, for example, using the REST or SOAP protocols, or the like. The system 400 can be one or more modules, applications and/or customizations of a platform or other framework software executing on an application server or an application node.

The system 400 includes a report processor module 402 and an event processor module 404. The report processor module 402 receives requests to generate content, such as the results generated from a report or query. Generating a report can include executing database queries, executing program instructions, communicating with components which are not part of the system 400, or a combination thereof. The report processor module 402 returns the content of the component (i.e., the results of generating a report) to the requester. The report processor module 402 can receive an indication of an output format to return the results from the requester or from an internal system that optimizes the output format based upon various performance related parameters. For example, the report processor module 402 can receive an indication to provide, including but not limited to, textual data (e.g. a list or matrix of data) or graphical data (e.g. a graph or chart) or both. The requester can be a person, such as a human user of the client 104 of FIG. 1, an automated process initiating the request on behalf of a person, or any other entity capable of initiating a request to and being serviced by the system 400. An entity capable of being serviced by the system can be an entity (e.g., a user) associated with an account (e.g., a user account) known to the system 400.

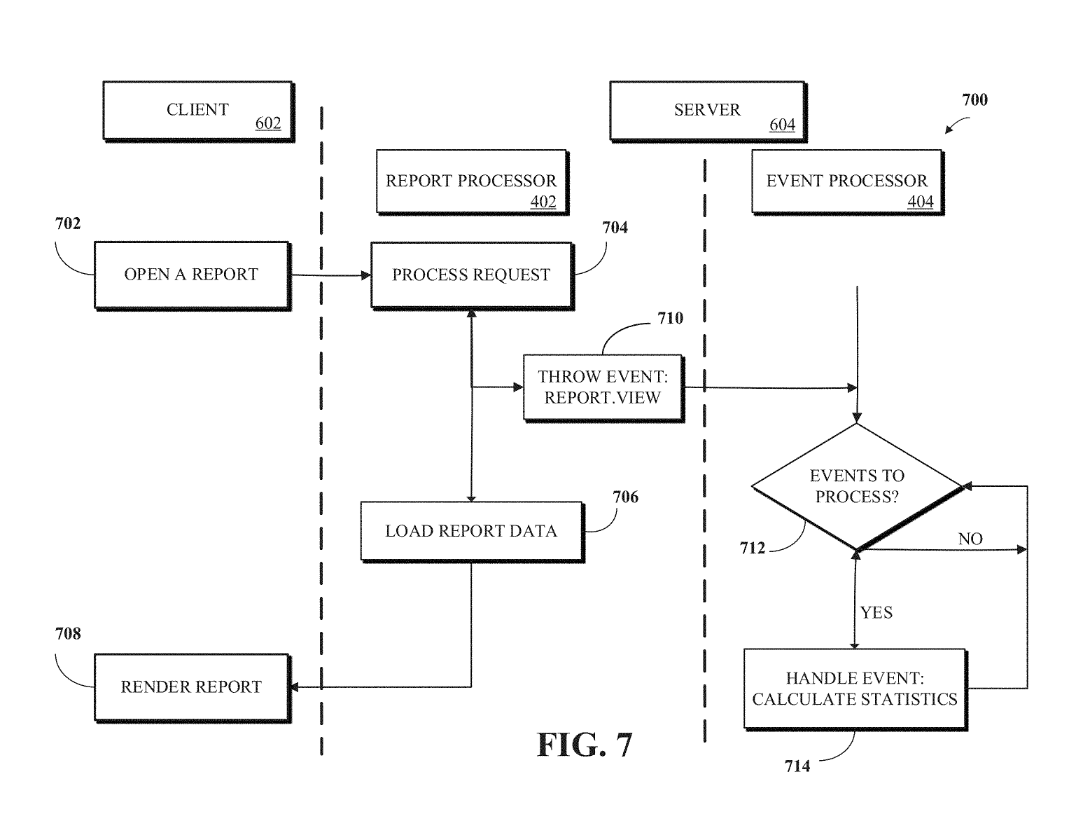

The event processor module 404 collects performance measurements regarding the performance of content generation and generates performance information based on the collected performance measurements. The event processor module 404 can also collect system and user/requester preferences and other historical data regarding browsing histories and current needs. The performance information can include statistics such as the number of executions of a report and the length of time it took report the event processor module 402 to generate the report. The performance measurements may vary by implementation. For example, in an implementation, the length of time can include the time it takes to do tasks other than content generation, such as transmission or reception of data, or pre- or post-processing of data. The event processor module 404 can be an asynchronous event processor as explained below with respect to FIG. 7.

FIG. 5 is an example of a data structure 500 used with a performance-based content generation system in accordance with the present disclosure. Referring to FIG. 4 and FIG. 5 together, the event processor module 404 can update the data structure 500 in response to the report processor module 402 generating a report. A user entry 506 can include a unique identifier of a user that submits the request to the report processor module 402 to generate a report. For example, the user entry 506 can be the user identifier of a user requesting the content of a component of a webpage. The user entry 506 can be a user name used by a user to log into the system 400 or can be the user's real name.

A report ID entry 508 is an identifier of the report to be generated by the report processor module 402. A report in the system 400 is identified with a unique ID that comprises the report ID entry 508. For example, the report that generates the content of the component 306 (“compliance requirements”) can be designated as report ID 234; and the report that generates the contents of component 310 can be designated as report ID 390. The data structure 500 includes a time entry 510 that can include the total number of milliseconds that the report processor module 402 required, for example, to generate a particular report from a particular user. The time entry 510 can either display the aggregate time required to generate all of the requests for a particular report or it can display the time required to generate each specific request. In another embodiment, the time entry 510 is in seconds or any other measure of time. The data structure 500 includes an invocation entry 512 that can include the total number of times a particular user has requested a particular report.

For example, a record 502 can be read as follows: User Nathan requested report ID 390 (e.g. the report of the component 310) 2 times (i.e., the invocation entry 512=2 for the record 502) and it took the report processor module 402 a total of 144,000 milliseconds to generate the 2 invocations. As such, on average, each invocation of report ID 390 for Nathan took 1 minute and 12 seconds. The data structure 500 can contain an aggregate entry for all users by report ID. In an example, while Nathan has invoked the report with report ID 234 five times (as record 503 associated with the invocation entry 512 indicates), all users (as record 504 indicates), including Nathan, have invoked the report with report ID 234 seven times requiring a total report processor module 402 time of 65,304 milliseconds. The user entry 506 can be a human user, an automated system, an external system, a batch process, a process, or any entity capable of making requests to the system 400. “User” as used herein means any requester as described above.

The data structure 500 can have different data elements than those shown in FIG. 5. The data structure 500 can have additional data elements, less data elements, or modified data elements. For example, the data structure 500 can add an average execution data element so that the average does not have to be calculated when needed. As another example, the data structure 500 can add a recent average execution data element to hold the average execution time of a more recent (or the most recent) content generation associated with a particular report. For example, recent average execution can measure the time required to generate a predefined number of at least one of the more recent content generation requests. For example, the recent average execution data can include the average time it took to generate the last ten most recent requests. As such, a recent average execution is a rolling average. The report processor module 402 provides facilities for selectively resetting elements and entries of the data structure 500. For example, the report processor module 402 can reset the data structure 500 by user, by report ID, or a combination thereof.

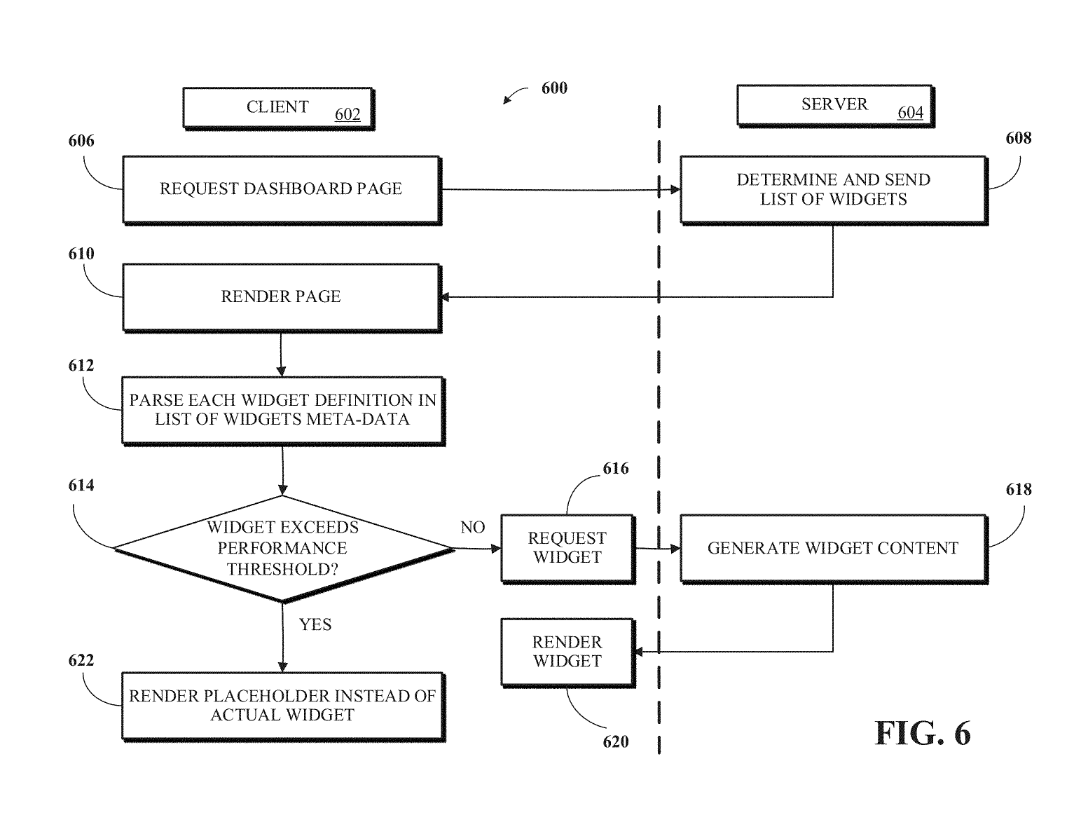

FIG. 6 is a flow diagram 600 illustrating an example of performance-based content generation in accordance with the present disclosure. The performance-based content generation can be performed in an electronic computing and communications system, such as the system 100 of FIG. 1. In some implementations, the flow diagram 600 can be executed using computing devices, such as the systems, modules, and devices described with respect to FIGS. 1-5. In some implementations, the flow diagram 600 can be performed, for example, by executing a machine-readable program or other computer-executable instructions, such as instructions or programs described according to JavaScript, C, or other such instructions. The steps, or operations, of the flow diagram 600 or any other technique, method, process, or algorithm described in connection with the implementations disclosed herein can be implemented directly in hardware, firmware, software executed by hardware, circuitry, or a combination thereof.

In some implementations, the flow diagram 600 includes operations performed by a client 602 and a server 604. The client 602 can be the client 104 of FIG. 1. The server 604 can be the system 400 of FIG. 4. In another implementation, a different combination of the operations of the flow diagram 600 are carried out by either the client 602 or the server 604. The operations of the client 602 include but are not limited to requesting a dashboard page, rendering a received page, for each widget in the page, parsing the meta-data of a widget definition in the list of widgets, determining whether generating the content of the widget exceeds a performance threshold, if not, requesting the content of the widget and rendering the content, otherwise rendering a placeholder (e.g., placeholder content) instead of the actual widget or content of the component. The operations of the server 604 include but are not limited to determining and sending to the client a list of widgets in response to the client request and generating the content of at least one widget of the list of widgets in response to the client requesting the content.

At step 606, the client 602 makes a request for a dashboard page of a webpage to the server 604. The client 602 making request for a dashboard page means that an application, such as a client application, operable on the client 602 makes the request. The dashboard page can be a webpage that contains at least one component of a plurality of components (i.e., all of the options for components that can be displayed on the dashboard page) to be requested from the server 604. At step 608, the server 604 determines a list of components (or widgets) from the plurality of components to be included in the requested dashboard page based on various metrics, and sends the list to the client 602. The server 604 sends the list of components to the client 602 along with the requested dashboard page that does not yet display or render the content of the components. The server 604 sends to the client 602 meta-data about at least one of the components in the list of components. The meta-data can include performance information for the at least one component. Meta-data can take a form such as described below in Table 1:

TABLE 1
Exemplary listing of meta-data.

“results”:[

{

“parent”:“3983f601cb10120032a09371c24c9c19”,
“has_children”:false,
“suggested_content”:false,
“name”:”Report”,
“attributes”:{

“sys_id”:“3983f881cb10120032a09371c24c9c19”,
“renderer”:“com.glide.ui.portal.RenderReport”,
“help_text_window”:“report _widget_description”,
“can_subscribe”:“true”,
“title”:“Report”

},
“render_time”:7,
“path_to_root”:“[‘Questions Posted in the Last

30 Days - Grouped’]”
}

In this example, the performance information includes a “render time” of “7.” The units used for the performance information can vary, such as millisecond, second, or the like. The performance information of the component can include an indication of the time expected to generate the content of the component. This indication can, for example, be based on a report ID associated with the component and previously collected performance measurements and generated performance information regarding the component. In an implementation, the server 604 can retrieve performance information by querying the report processor module 402 of FIG. 4 which, in turn, can extract the performance information from the data structure 500 of FIG. 5 based on a requested report ID. At least a portion of the performance information can be calculated by dividing the time entry 510 by the invocation entry 512 of FIG. 5 for the requested report ID. The performance information can, for example, be calculated based on the entries in the data structure 500 for a specific user of the client 602, a specific combination of the users, or for all users.

At step 610, the client 602 renders the requested dashboard page that has been received from the server 604. For example, the client 602 can render the page header 302 of FIG. 3, a sidebar (not shown), and the content area 304 of FIG. 3 that is empty in preparation of rendering content associated with the list of components.

Steps 612-622 are executed for each component in the list of components determined by the server 604 at step 608. At step 612, the client 602 extracts the returned meta-data including the performance information for a component. At step 614, if the client 602 determines that a component's performance information exceeds a performance threshold, the client 602 executes step 622, by rendering a placeholder content instead of the content of the component (or widget), otherwise it executes step 616. In another embodiment, if the client 602 determines that a component's performance information exceeds a performance threshold, the client 602 omits the component from the rendering of the webpage and does not even provide or generate a placeholder. In another embodiment, the comparison of the performance information and the performance threshold is done by the server 604 prior to the generation of the component contents that are displayed on the webpage by the client 602.

The performance threshold can be, for example, a user preference, a system setting, an administrator setting, a throttle based on server 604's load (e.g., number of users accessing server 604 or percent of CPU usage), dynamically updated thresholds based on machine learning analysis of aggregated data, or a combination thereof. For example, a user can indicate, as a user preference, that widgets exceeding 5 seconds to generate should not be rendered. In another example, a system throttle can be set such that widgets requiring more than 10 seconds to generate should not be generated if there are more than 1000 concurrent users accessing the server 604; but that widgets requiring more than 20 seconds should not be generated when there are more than 500 concurrent users accessing the server 604. Different performance thresholds can be simultaneously supported. For example, a user preference can have precedence over a system preference or vice versa. For example, a threshold can be set as a global constant in platform software and can be communicated to the client 602 in the webpage sent to the client 602 by the server 604.

At step 616, the client 602 makes a request to the server 604 for the content of the components from the list of the components that are determined to not exceed the performance threshold. At step 618, the server 604 generates, and returns to the client 602, the content of the selected components. Step 618 is described further in FIG. 7. At step 620, the client 602 renders the component's content. At step 622, the client 602 can render placeholders (of varying types) for the content of the components from the list of components that are determined to exceed the performance threshold or are not selected for rendering for another reason (e.g., user browsing history shows they do not care about that content).

The placeholder can be a generic image representative of content that would otherwise be generated for the component. For example, if the component can be configured to display the results as a horizontally stacked histogram, then the placeholder is a generic image of a horizontally stacked histogram, as shown by the component 310 of FIG. 3. The placeholder can include other content such as a bounding box with a text or an indication that the user can click on a specific area (e.g., action button) to generate and load the requested content of the component. The default behavior of the performance-based content generation system can be changed, such as by indicating to the system that for a certain component the performance metrics should be ignored and that the component should always be loaded. For example, a user can configure a component such that its content is generated regardless of the time required to generate the content or any other performance metrics. In another example, the content of a component is never loaded regardless of the performance metrics.

FIG. 7 is a flow diagram 700 of an example of steps for generating component content of a performance-based content generation system in accordance with the present disclosure. Referring to FIGS. 4, 5, 6, and 7 together, and as indicated above, the flow diagram 700 further illustrates the operation of step 618 which generates component or widget content (in other words, the content of the component). The server 604 can be the system 400. As such, the server 604 is shown to include a report processor module 402 and an event processor module 404.

At step 702, the client 602 opens a report. For example, opening a report can include a user navigating to a webpage which includes the report, thus causing a request to the server 604 for the report. Alternatively, opening a report can include a user otherwise explicitly requesting the report by performing an action on the client 602. In an implementation, opening a report can mean requesting the content of a component, such as through step 616. At step 704, the report processor module 402 processes the request and generates the report content. Processing the request can include parsing information included in the request to determine what content is to be generated. The report processor module 402 can keep track of the time taken to process the request. At step 706, the report processor module 402 can load and/or prepare the report data (including any meta-data) and send it to the client 602. The client 602 can then render the report at step 708. Rendering the report by the client 602 can include displaying the report on a display device (e.g., smartphone, tablet, or other portable/non-portable computing device) connected to the client 602.

When the report processor module 402 completes processing the request at step 704, it can create or throw an event, which can include the report ID of the report and the time to generate it, to the event processor module 404, via step 710. In response to receiving the event from the report processor module 402, at step 714, the event processor module 404 can update the data structure 500 using the event parameters. The event processor module 404 can, for example, increment the invocation entry 512 and update the time entry 510. After processing, calculating, and/or generating the performance information and/or statistics, the event processor module 404 returns to step 712 to wait for a next event to handle.

Step 714 can handle the event and calculate performance information. An ID of the event can be retrieved and an ID of the report or webpage can be retrieved. Information about the number of times that a report has been retrieved (or has been requested to be retrieved or at what times the most requests have been made, etc.), such as for the webpage or for the user can be retrieved from a data store, such as from the data structure 500. The number of invocations can be incremented by one, the total execution time increased by the execution time associated with the event, and the data structure can be correspondingly updated. The average execution time and recent average execution times, to the extent that they are stored in the data structure 500 can be updated. To the extent that other statistics are maintained, they can also be updated.

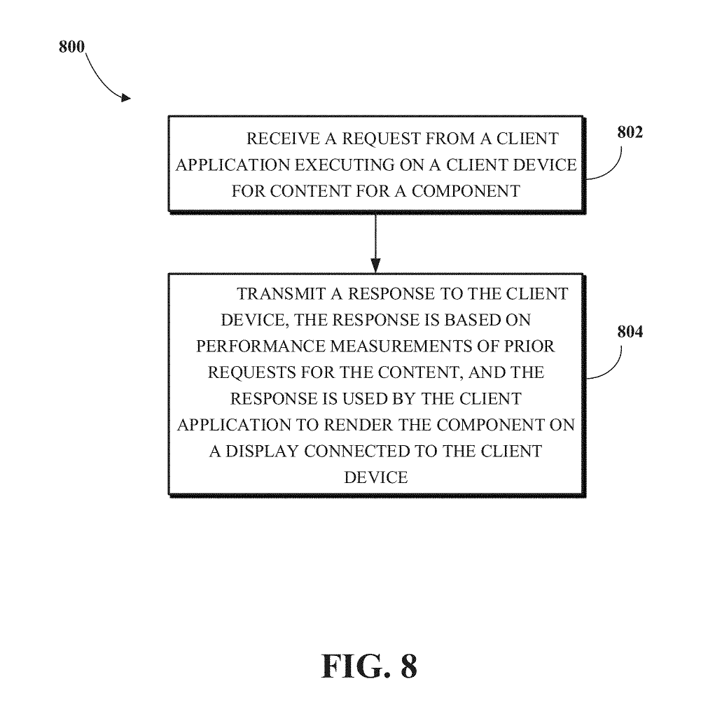

FIG. 8 is an example of a technique 800 for performance-based generation of content for a component in accordance with the present disclosure. The component can be referenced for display within a webpage. The technique 800 can be performed in an electronic computing and communications system, such as the system 100 of FIG. 1. In some implementations, the technique 800 can be executed using computing devices, such as the systems, modules, and devices described with respect to FIGS. 1-5. In some implementations, the technique 800 can be performed, for example, by executing a machine-readable program or other computer-executable instructions, such as instructions or programs described according to JavaScript, C, or other such instructions. The steps, or operations, of the technique 800 or any other technique, method, process, or algorithm described in connection with the implementations disclosed herein can be implemented directly in hardware, firmware, software executed by hardware, circuitry, or a combination thereof.

In some implementations, the technique 800 includes operations 802-804. The technique 800 is implemented by a performance-based content generation system (similar to the system 400 of FIG. 4). The technique 800 can be executed using computing devices, such as the systems, modules, and devices described with respect to FIGS. 1-5. The technique 800 can be performed, for example, by executing a machine-readable program or other computer-executable instructions, such as instructions or programs described according to JavaScript, C, or other such instructions. The steps, or operations, of the technique 800 or any other technique, method, process, or algorithm described in connection with the implementations disclosed herein can be implemented directly in hardware, firmware, software executed by hardware, circuitry, or a combination thereof.

At operation 802, a request is received by a server from a client application executing on a client device for content for the component. At operation 804, a response is transmitted to the client device. The response is based on performance measurements of prior requests for the content. The response is used by the client application to render the component on a display connected to the client device. The operations 802 and 804 can be performed as described with respect to the steps of FIGS. 6 and 7.

The technique 800 can include receiving a first request from the client application for the webpage and transmitting the webpage to the client device including a reference to the component where the request from the client application for content for the component is based on the reference to the component. The technique can also include receiving a first request from the client application for the webpage and transmitting the webpage to the client device including a reference to the component, where the request from the client application for content for the component is based on the reference to the component. The technique 800 can also include generating the content for the component responsive to the performance measurements not exceeding a threshold, wherein the response includes the content for the component.

In some implementations, the technique 800 can include indicating in the response that the content for the component cannot be generated responsive to the performance measurements exceeding the threshold. In some implementations, indicating in the response to the client device that the content for the component cannot be generated includes providing a placeholder content in the response.

The technique 800 can further include determining a generation time to generate the content for the component and updating the performance measurements with the generation time. In some implementations of the technique 800, the performance measurements are based on performance measurements of prior requests for the content from the requester. In some implementations, the performance measurements are based on performance measurements of prior requests for the content from a plurality of requesters or all of the requesters.

Although the steps of the flow diagrams 600 and 700 and technique 800 in FIGS. 6-8 are shown as series of operations for clarity, implementations of the 600, 700, 800 or any other technique, process, steps, or algorithm described in connection with the implementations disclosed herein can be performed in various orders or concurrently. Additionally, operations in accordance with this disclosure can be performed with other operations not presented and described herein. Furthermore, one or more aspects of the systems and techniques described herein can be omitted.

For example, instead of sending a list of components at step 608, the server 604 can send a complete webpage/dashboard (including the content of each component) in response to the received request such that the client 602 does not need perform steps 612-622. The complete webpage can include component content or placeholders based on a comparison of performance metric(s) and performance information carried out by the server 604 before the webpage is transmitted to the client 602. For example, the event processor module 404 of FIG. 4 can be implemented synchronously. For example, step 714 can be implemented between steps 704 and 706 or between steps 706 and 708 or between other steps. For example, step 614 can be performed at the server 604. In this implementation, the list of components generated at step 608 includes an explicit indication of which components should be requested at step 616 (so that their content is displayed) and which components should render a placeholder.

Another implementation of this disclosure is a system for performance-based generation of content for a component referenced for display within a webpage. The system includes a means for receiving a request from a client application executing on a client device for content for the component The system also includes a means for transmitting a response to the client device. The response is based on performance measurements of prior requests for the content and the response is used by the client application to render the component on a display connected to the client device.

Another implementation of this disclosure is a system for selectively displaying content of a component within a webpage on a client device. The system includes a means for requesting, from a server device, the content of the component for display within the webpage, a means for receiving a response from the server device, a means substituting the content of the component with a placeholder for display within the webpage on the client device in response to the response indicating that generating the content of the component exceeds a performance threshold.

All or a portion of the implementations of the systems and techniques described herein can be implemented using a general-purpose computer/processor with a computer program that, when executed, carries out any of the respective techniques, algorithms, or instructions described herein. In addition, or alternatively, for example, a special-purpose computer/processor can be utilized, which can include specialized hardware for carrying out any of the techniques, algorithms, or instructions described herein.

The implementations of computing devices as described herein (and the algorithms, techniques, instructions, etc., stored thereon or executed thereby) can be realized in hardware, software, or a combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination.

For example, one or more computing devices can include an ASIC or programmable logic array (e.g., a field-programmable gate array (FPGA)) configured as a special-purpose processor to perform one or more of the operations described or claimed herein. An example FPGA can include a collection of logic blocks and random access memory (RAM) blocks that can be individually configured or configurably interconnected in order to cause the FPGA to perform certain functions. Certain FPGAs can contain other general- or special-purpose blocks as well. An example FPGA can be programmed based on a hardware definition language (HDL) design, such as VHSIC Hardware Description Language or Verilog.

The implementations disclosed herein can be described in terms of functional block components and various processing operations. Such functional block components can be realized by any number of hardware or software components that perform the specified functions. For example, the described implementations can employ various integrated circuit components (e.g., memory elements, processing elements, logic elements, look-up tables, and the like), which can carry out a variety of functions under the control of one or more microprocessors or other control devices. Similarly, where the elements of the described implementations are implemented using software programming or software elements, the systems and techniques can be implemented with any programming or scripting language, such as C, C++, Java, assembler, or the like, with the various algorithms being implemented with a combination of data structures, objects, processes, routines, or other programming elements. Functional aspects can be implemented in algorithms that execute on one or more processors. Furthermore, the implementations of the systems and techniques could employ any number of conventional techniques for electronics configuration, signal processing or control, data processing, and the like. The words “mechanism” and “element” are used broadly and are not limited to mechanical or physical implementations, but can include software routines in conjunction with processors, etc.

Likewise, the terms “module” or “monitor” as used herein and in the figures may be understood as corresponding to a functional unit implemented using software, hardware (e.g., an ASIC), or a combination of software and hardware. In certain contexts, such modules or monitors may be understood to be a processor-implemented software module or software-implemented monitor that is part of or callable by an executable program, which may itself be wholly or partly composed of such linked modules or monitors.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media, and can include RAM or other volatile memory or storage devices that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

The word “example” is used herein to mean serving as an example, instance, or illustration. Any aspect or design described herein as “example” is not necessarily to be construed as preferred or advantageous over other aspects or designs. Rather, the use of the word “example” is intended to present concepts in a concrete fashion. The use of any and all examples, or language suggesting that an example is being described (e.g., “such as”), provided herein is intended merely to better illuminate the systems and techniques and does not pose a limitation on the scope of the systems and techniques unless otherwise claimed. As used in this disclosure, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. For example, if X includes A; X includes B; or X includes both A and B, then “X includes A or B” is satisfied under any of the foregoing instances. In addition, the articles “a” and “an” as used in this disclosure and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

The particular implementations shown and described herein are illustrative examples of the systems and techniques and are not intended to otherwise limit the scope of the systems and techniques in any way. For the sake of brevity, conventional electronics, control systems, software development, and other functional aspects of the systems (and components of the individual operating components of the systems) cannot be described in detail. Furthermore, the connecting lines, or connectors, shown in the various figures presented are intended to represent example functional relationships or physical or logical couplings between the various elements. Many alternative or additional functional relationships, physical connections, or logical connections can be present in a practical device. Moreover, no item or component is essential to the practice of the systems and techniques unless the element is specifically described as “essential” or “critical.”

The use of the terms “including,” “comprising,” “having,” or variations thereof herein is meant to encompass the items listed thereafter and equivalents thereof as well as additional items. Unless specified or limited otherwise, the terms “mounted,” “connected,” “supported,” “coupled,” or variations thereof are used broadly and encompass both direct and indirect mountings, connections, supports, and couplings. Further, “connected” and “coupled” are not restricted to physical or mechanical connections or couplings.

Unless otherwise indicated herein, the recitation of ranges of values herein is intended merely to serve as a shorthand alternative to referring individually to respective separate values falling within the range, and respective separate values are incorporated into the specification as if individually recited herein. Finally, the operations of all techniques described herein are performable in any suitable order unless clearly indicated otherwise by the context.

All references, including publications, patent applications, and patents, cited herein are hereby incorporated by reference to the same extent as if respective references were individually and specifically indicated as being incorporated by reference and were set forth in its entirety herein.

The above-described implementations have been described in order to facilitate easy understanding of the present systems and techniques, and such descriptions of such implementations do not limit the present systems and techniques. To the contrary, the present systems and techniques are intended to cover various modifications and equivalent arrangements included within the scope of the appended claims, which scope is to be accorded the broadest interpretation as is permitted by law so as to encompass all such modifications and equivalent arrangements.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system for performance-based generation of content for a component referenced for display within a webpage, the system comprising a server having a processor and a memory, wherein the memory includes instructions executable by the processor to:
receive a request from a client application executing on a client device for content for the component; and
transmit a response to the client device,
wherein the response is based on performance measurements of prior requests for the content, and
wherein the response is used by the client application to render the component on a display connected to the client device.

2. The system of claim 1, wherein the memory further includes instructions executable by the processor to:
receive a first request from the client application for the webpage; and
transmit the webpage to the client device including a reference to the component, wherein the request from the client application for content for the component is based on the reference to the component.

3. The system of claim 1, wherein the memory further includes instructions executable by the processor to:
generate the content for the component responsive to the performance measurements not exceeding a threshold, wherein the response includes the content for the component.

4. The system of claim 3, wherein the memory further includes instructions executable by the processor to:
indicate in the response that the content for the component cannot be generated responsive to the performance measurements exceeding the threshold.

5. The system of claim 4, wherein the memory further includes instructions executable by the processor to:
provide a placeholder content in the response responsive to the performance measurements exceeding the threshold.

6. The system of claim 3, wherein the memory further includes instructions executable by the processor to:
determine a generation time to generate the content for the component; and
update the performance measurements with the generation time.

7. The system of claim 1, wherein the client device is associated with a requester, and wherein the performance measurements are based on performance measurements of prior requests for the content from the requester.

8. The system of claim 1, wherein the performance measurements are based on performance measurements of prior requests for the content from a plurality of requesters.

9. A method for performance-based generation of content for a component referenced for display within a webpage, the method comprising:
receiving a request from a client application executing on a client device for content for the component; and
transmitting a response to the client device,
wherein the response is based on performance measurements of prior requests for the content, and
wherein the response is used by the client application to render the component on a display connected to the client device.

10. The method of claim 9, further comprising:
receiving a first request from the client application for the webpage; and
transmitting the webpage to the client device including a reference to the component, wherein the request from the client application for content for the component is based on the reference to the component.

11. The method of claim 9, further comprising:
generating the content for the component responsive to the performance measurements not exceeding a threshold, wherein the response includes the content for the component.

12. The method of claim 11, further comprising:
indicating in the response that the content for the component cannot be generated responsive to the performance measurements exceeding the threshold.

13. The method of claim 12, further comprising:
providing a placeholder content in the response responsive to the performance measurements exceeding the threshold.

14. The method of claim 11, further comprising:
determining a generation time to generate the content for the component; and
updating the performance measurements with the generation time.

15. The method of claim 9, wherein the client device is associated with a requester, and wherein the performance measurements are based on performance measurements of prior requests for the content from the requester.

16. The method of claim 9, wherein the performance measurements are based on performance measurements of prior requests for the content from a plurality of requesters.

17. A non-transitory computer-readable storage medium for performance-based generation of content for a component referenced for display within a webpage, wherein the non-transitory computer-readable storage medium includes program instructions executable by one or more processors that, when executed, cause the one or more processors to perform operations, the operations comprising:
receiving a request from a client device to display the webpage on the client device;
determining whether to generate the content for the component based on performance measurements associated with the component;
generating the content for the component responsive to a determination that the performance measurements satisfy a performance threshold; and
sending a response to the client device including the generated content.

18. The non-transitory computer-readable storage medium of claim 17, the operations further comprising:
generating a placeholder in substitution of the content responsive to a determination that the performance measurements do not satisfy the performance threshold.

19. The non-transitory computer-readable storage medium of claim 18, wherein the placeholder comprises an interface element that permits an operator of the client device to request the content of the component from the server device.

20. The non-transitory computer-readable storage medium of claim 19, the operations further comprising:
in response to the operator interacting with the interface element, initiating a request for the content of the component;
receiving the content of the component from the server device; and
replacing the placeholder with the content of the component received from the server device.
